(19) United States
(12) Patent Application Publication
(10) Pub. No.: US 2002/0167386 A1
(43) Pub. Date: Nov. 14, 2002

(54) Operating device for light sources having cost-effective wound items

(75) Inventors: Gunther Loehmann, Seltz (FR); Klaus Schadhauser, Muenchen (DE)

Correspondence Address: OSRAM SYLVANIA INC, 100 ENDICOTT STREET, DANVERS, MA, 01923, US

(73) Assignee: Patent-Treuhand-Gesellschaft Fur elektrische Gluhlampen mgH, Munchen (DE)

(21) Appl. No.: 10/132,209

(22) Filed: Apr. 26, 2002

(30) Foreign Application Priority Data
May 10, 2001 (DE) 10122686.1

(51) Int. Cl. H01F 27/28

(52) U.S. Cl. 336/182

(57) ABSTRACT

Operating device for operating light sources, having at least one inductor in the form of a wound item with wire ends (7, 8), characterized in that the wound item includes a part (1) that both is magnetically active and accomplishes the fixing of the wire ends (7, 8), said part being produced from one material throughout.

### TECHNICAL FIELD

The invention proceeds from an operating device according to the preamble of claim 1. In particular, this is an operating device for operating fluorescent lamps that includes particularly cost-effective wound items of small dimensions.

### BACKGROUND ART

For operating devices for light sources, in particular electronic operating devices for fluorescent lamps, there are two essential criteria which form the nub of the further development: size and costs. An important role in the size and the costs of an operating device for light sources, termed operating device below for short, is played by what are termed the wound items. These are inductors which are designed as a wire winding, called simply winding below, on a ferromagnetic core.

Cost-effective wound items include a core in a simple geometric shape. If the wound item is to have small dimensions, it is advantageous if the core surrounds the winding as far as possible. This additionally prevents the propagation of interference fields. However, such wound items require core shapes that are geometrically complicated and can be produced only with a relatively high outlay on costs.

### DISCLOSURE OF THE INVENTION

It is an object of the present invention to provide an operating device in accordance with the preamble of claim 1 whose wound items simultaneously have small dimensions and are cost-effective.

This object is achieved in the case of an operating device having the features of the preamble of claim 1 by means of the features of the characterizing part of claim 1. Particularly advantageous refinements are to be found in the dependent claims.

A wound item is constructed in general from a plurality of parts. In addition to the winding with its wire ends, there are essentially two types of parts. One type of parts is chiefly magnetically active; that is to say it consists of a ferromagnetic material and serves to guide the magnetic field. The other type of parts is chiefly mechanically active. This type of parts serves, for example, to hold the winding or as holder for the magnetically active parts. An important task of mechanically active parts is to fix the wire ends to the winding. The fixing permits electric contact with the wound item.

In order to reduce the costs of a wound item, it is necessary to reduce the number of parts comprising it. According to the invention, a wound item has parts that act both magnetically and mechanically. This reduces the number of the parts and thus the costs. In particular, the fixing of the wire ends is taken over by a part that is simultaneously magnetically active.

Magnetically active parts are produced as a rule from a sintered ferrite. Consequently, it is difficult to produce such parts in a complex shape. However, if the aim according to the invention is for a magnetically active part also to take over mechanical tasks, there is mostly a need for complex shapes. In order to solve this problem, parts that are active both magnetically and mechanically are advantageously produced from a composite material which contains ferrite and polymers and can thereby be produced using an injection-molding method.

Usually, the magnetically active parts of an inductor can be designed with an air gap. The value of the inductance is determined substantially by the size of the air gap. Manufacturing tolerances that relate to the air gap therefore lead to tolerances in the value of the inductance. The composition of the abovementioned composite material can be designed from ferrite and polymer such that it acts like an air gap distributed over an entire part. According to the invention, the overall air gap of an inductor is advantageously formed by suitable selection of the composition of the composite material. Smaller tolerances can thereby be achieved for the value of an inductance.

As explained above, it is important that the winding be surrounded as completely as possible by magnetically active parts. According to the invention, this is achieved by virtue of the fact that the wound item includes parts that are pushed into one another. These are advantageously two parts made from said composite material that by being pushed into one another form a cavity which accommodates the winding.

According to the invention, one part forms a pot to enable simple production. Pushed into this pot is a roller onto which the winding is applied. Conversely, one part can also form a roller over which a tubular or pot-shaped part is pushed. Again, the winding is applied to the roller.

### BRIEF DESCRIPTION OF THE DRAWINGS

The invention is to be explained in more detail below with the aid of an exemplary embodiment. In the drawing:

FIG. 1 shows a plan view of an exemplary embodiment, and

FIG. 2 shows a sectional illustration of the exemplary embodiment in FIG. 1.

### BEST MODE FOR CARRYING OUT THE INVENTION

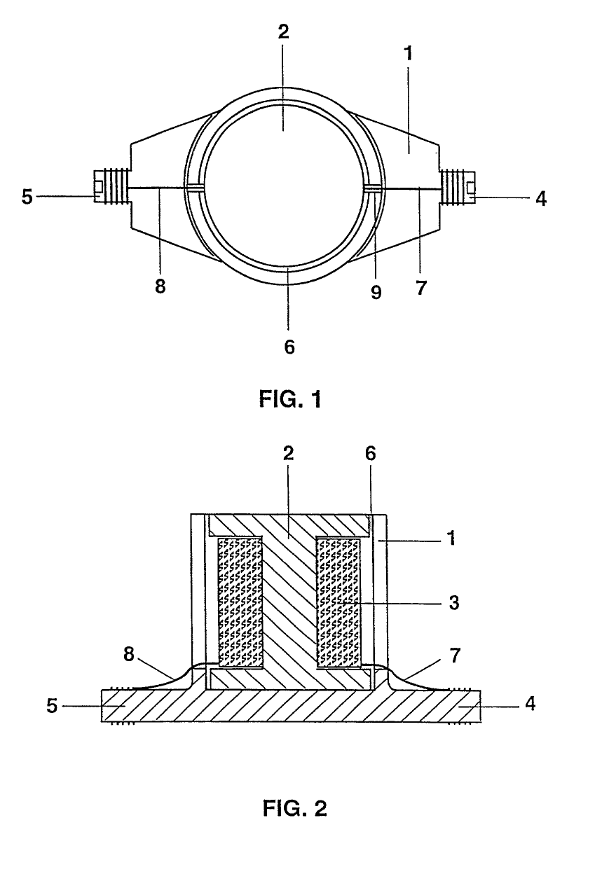

Illustrated in FIG. 1 is a wound item that includes two parts 1 and 2, which are both magnetically and mechanically active. Both parts 1 and 2 are advantageously produced from a composite material described above. The part 1 forms a pot-shaped depression into which the part 2 is pushed. The part 2 is essentially a roller of which only the upper disk-shaped termination is to be seen in the plan view. An air gap 6 is formed between the part 1 and the part 2. It is possible to dispense with said gap if the material for the parts 1 and 2 is selected such that it can take over the task of the air gap 6.

Individually formed on the part 1 are stubs 4 and 5 onto which wire ends 7 and 8 are wound. These wound-on wire ends form the connecting contacts of the wound item. The wall of the pot-shaped depression is provided with slits 9 so that the wire ends 7 and 8 can be guided into the interior of the pot-shaped depression. According to the invention, the part 1 is a part that is produced from one material throughout and is both magnetically active and forms a mounting platform.

The exemplary embodiment from FIG. 1 is illustrated in section in FIG. 2. Identical components are provided with identical numbers. Clearly visible is the roller shape of part 2 on which the winding 3 is applied. It is also clear from FIG. 2 how the wire ends 7 and 8 come to lie in a slit in the wall of the pot-shaped depression of part 1.

As already indicated in the summary of the invention, part 1 can also be shaped so as to form, on a mounting platform, a roller onto which the winding is applied. A tubular or pot-shaped part is then pushed over this roller, the winding being surrounded thereby.

1. An operating device for operating light sources, having at least one inductor in the form of a wound item with wire ends (7, 8), characterized in that the wound item includes a part (1) that both is magnetically active and accomplishes the fixing of the wire ends (7, 8), said part being produced from one material throughout.

2. The operating device as claimed in claim 1, characterized in that said part (1) is produced from a composite material which contains ferrite and polymers.

3. The operating device as claimed in claim 2, characterized in that the value of the inductance of the wound item is substantially determined by the composition of the composite material.

4. The operating device as claimed in claim 1, characterized in that apart from a winding (3) the wound item essentially consists of two parts (1, 2) that are pushed into one another.

5. The operating device as claimed in claim 4, characterized in that one of the parts (1) is pot-shaped or tubular, while the other part (2) is in the shape of a roller.
